(19) United States
(12) Patent Application Publication
(10) Pub. No.: US 2023/0312800 A1
(43) Pub. Date: Oct. 5, 2023

(54) HIGH STRENGTH CYANOACRYLATE-BASED TAPES

(71) Applicant: Henkel AG & Co. KGaA, Duesseldorf (DE)

(72) Inventors: Rory Barnes, Lucan (IE); Michael Doherty, Clane (IE); Nigel Sweeney, Terenure (IE); Ciara Goff, Wexford (IE)

(21) Appl. No.: 18/207,481

(22) Filed: Jun. 8, 2023

Related U.S. Application Data
(63) Continuation of application No. PCT/EP2021/084290, filed on Dec. 3, 2021.

(30) Foreign Application Priority Data
Dec. 9, 2020 (GB) 2019414.8

(51) Int. Cl. C08F 283/00; C09J 4/06; C09J 7/38; C09J 175/06; C08K 3/38; C08K 3/30

(52) U.S. Cl. CPC C08F 283/006; C09J 4/06; C09J 7/38; C09J 175/06; C08K 3/38; C08K 3/30; C09J 2301/302; C09J 2301/40; C09J 2451/00; C09J 2475/00; C09J 2433/00

(57) ABSTRACT

The present invention relates to a curable composition comprising a curable cyanoacrylate component and at least one thermoplastic polyurethane (TPU) component. The compositions of the invention are non-flowable at room temperature (25° C.) and are suitable for use as adhesive compositions, for example in a tape form.

### BACKGROUND

### Field

The present invention relates to curable cyanoacrylate compositions that are non-flowable at room temperature (25° C.) and that are suitable for use as adhesive compositions, such as for example in a tape form.

### Brief Description of Related Technology

Cyanoacrylate monomers that are solid at room-temperature are known, such as phenylethyl cyanoacrylate, ethylhexyl cyanoacrylate, and hexadecyl cyanoacrylate. Such room-temperature solid cyanoacrylate monomers can be used to prepare stick form and tape-form cyanoacrylate products. However compositions based on these monomers perform poorly relative to compositions comprising conventional room temperature liquid-form cyanoacrylate monomers, over a range of metrics. Furthermore, solid cyanoacrylate monomers are typically non-standard specialty chemicals that are costly and difficult to synthesize.

Cyanoacrylate tapes previously developed by Henkel have been based on monomers that are solid at room temperature, such as phenylethyl cyanoacrylate. However, the use of solid cyanoacrylate monomers to produce an adhesive tape prohibits their use as “instant tack” tapes and negates the primary advantage of using cyanoacrylates as instant adhesives.

Liquid cyanoacrylate monomers allow for better diffusion through the bulk, giving faster room temperature cure than solid cyanoacrylate monomers.

However, tapes based on standard liquid cyanoacrylate monomers are difficult to achieve. This is not only due to the inherent reactivity of the cyanoacrylate monomers towards film formers themselves, but also because materials with sufficient structural integrity are required to achieve adequate film formation.

Within the patent literature, the following documents demonstrate adhesive compositions which have been formulated for use in tape form.

US Patent Application No. 2015/0107761 discloses a tape comprising a curable film on a release substrate and/or carrier substrate. The curable film comprises at least one specific cyanoacrylate monomer and at least one film forming (co)polymer.

U.S. Pat. No. 5,147,938 discloses an adhesive transfer tape based a polymeric adhesive composition comprising pressure-sensitive acrylate-base copolymers.

US Patent No. 20060029810 discloses adhesive transfer tapes comprising pressure-sensitive adhesive compositions, based on liquid epoxy resin, which are cured at elevated temperatures.

WO2003020841 discloses pressure-sensitive adhesive compositions comprising an acrylic copolymer and at least two tackifiers. The compositions can be used to prepare a pressure-sensitive adhesive tape.

It would be advantageous to develop an adhesive tape which achieves instant tack without the need for heating under pressure.

### SUMMARY OF THE INVENTION

In one aspect, the present invention comprises a curable composition comprising:
(i) a curable cyanoacrylate component; and
(ii) at least one thermoplastic polyurethane (TPU) component; and
   wherein said at least one TPU component (ii) has a mass average molar mass Mw from 40,000-80,000, and
   wherein said TPU component (ii) is based on a polyol that is based on at least one diol or dicarboxylic acid, wherein said at least one diol or dicarboxylic acid has 6 carbon atoms (C₆) in its main chain and further wherein none of said diols or dicarboxylic acids have greater than 10 carbon atoms (>C₁₀) in their main chain, and wherein said at least one TPU component (ii) is present in the curable composition in an amount of greater than about 50 wt %, wherein the weight percentage is based on the total weight of the composition.

The compositions of the invention are non-flowable at room temperature (25° C.) and are suitable for use as adhesive compositions, for example in a tape form. The compositions can be applied onto a release liner. For example, an interliner layer or a liner with differential release values may be used. The compositions can be applied by using a suitable solvent, for example cast from a suitable solvent onto the liner.

The curable cyanoacrylate component (i) may be selected from the group comprising ethyl cyanoacrylate, butyl cyanoacrylate, β-methoxy cyanoacrylate and combinations thereof.

The curable cyanoacrylate component (i) may be present in the curable composition in an amount from about 10 wt % to about 35 wt %, wherein the weight percentage is based on the total weight of the composition.

The at least one TPU component (ii) may be present in the curable composition in an amount from about 65 wt % to about 85 wt %, wherein the weight percentage is based on the total weight of the composition.

In some embodiments, the at least one TPU component (ii) has a glass transition temperature of from about −60° C. to about −5° C., for example from about −50° C. to about −10° C.

Desirably, the at least one TPU component (ii) has a glass transition temperature of from about −55° C. to about −20° C., such as from about −50° C. to about −30° C.

The TPU component (ii) is based on a polyol which is based on at least one diol or dicarboxylic acid having 6 carbon atoms (C₆) in its main chain.

The TPU component (ii) may be based on a polyol which is also based on one or more additional diols or dicarboxylic acids, provided that none of said diols or dicarboxylic acids have greater than 10 carbon atoms (>C₁₀) in their main chain.

In some embodiments of the invention, the at least one TPU component (ii) comprises polyester segments.

Desirably, the TPU component (ii) comprises polyester segments based on at least one of a C6 diol or a C6 carboxylic acid.

The at least one TPU component (ii) may be based on a polyester polyol formed from a C6 dicarboxylic acid and one of either 1,6-hexane diol or 1,4-butane diol.

Desirably, the at least one TPU component (ii) is based on a (co)polyester of hexanedioic acid and one of either 1,4-butane diol or 1,6-hexanediol, said (co)polyester having a melting point of about 50-80° C., and with an OH number of less than about 0.5%, for example less than about 0.1% (as measured according to standard procedure DIN 53240-2).

In some embodiments, only one TPU components is present in the composition.

In some embodiments, the composition of the invention may comprise two or more TPU components.

Desirably, when the composition of the invention comprises two or more TPU components, each TPU component present has a mass average molar mass Mw from 40,000-80,000. Desirably, each TPU component is based on a polyol that is based on at least one diol or dicarboxylic acid having 6 carbon atoms (C₆) in its main chain.

The composition of the invention may further comprise one or more further TPU components which is/are different from the at least one TPU mentioned above, provided that said one or more further TPUs is not based on a polyol which is based on a diol or dicarboxylic acid having greater than 10 carbon atoms (>C₁₀) in their main chain. Such additional TPU may be present in an amount such that the total TPU content may be up to about 95% by weight based on the total weight of the composition.

The composition of the invention may further comprise at least one solvent. The use of a solvent may be beneficial, for example, for formulation or dispensing purposes.

However, wherever weight percentages are used, they are based on the total weight of the composition without solvent.

In some embodiments, the invention comprises a solvent selected from the group comprising ethyl acetate, tetrahydrofuran, methyl ethyl ketone, cyclohexanone, and acetone.

Desirably, the invention comprises ethyl acetate as a solvent.

The invention may further comprise a stabiliser of the cyanoacrylate component.

In some embodiments, a stabiliser of the cyanoacrylate component is present in an amount of from about 10 ppm to about 200 ppm, for example from about 25 ppm to about 100 ppm.

The stabiliser may be selected from boron trifluoride (BF₃) or sulfur dioxide (SO₂).

Desirably, the stabiliser is sulfur dioxide (SO₂).

The invention also relates to a tape comprising a curable composition according to the invention and one or more release liners.

A tape of the present invention may be a transfer tape. The release liner(s) may be used to transfer the curable composition, for example in film form, to at least one substrate.

Tapes of the present invention may exhibit adhesion properties at room temperature, wherein the curable composition of the article may be attached to at least one surface through the application of mild pressure to the tape. The cyanoacrylate component of the composition will act as an instant adhesive. Accordingly, the composition of the invention should instantly bond to any compatible substrate.

In another aspect, the invention also relates to a method of preparing a curable composition comprising the steps of:
i) combining at least one thermoplastic polyurethane (TPU) component as defined by the invention with a curable cyanoacrylate component as defined by the invention and a solvent to form a mixture;
ii) applying the mixture of step (i) to a substrate, optionally by casting;
iii) allowing the solvent to evaporate or actively removing the solvent, thereby forming a solid form curable composition.

In some embodiments of the method, the substrate is a release liner.

In some embodiments of the method, the solvent is ethyl acetate.

The at least one TPU component (ii) is present in the curable composition in an amount of greater than about 50 wt %, wherein the weight percentage is based on the total weight of the composition.

The at least one TPU component (ii) is present in amount equal to or higher than that of the curable cyanoacrylate component.

It is appreciated that in the method of the invention the TPU component may be as described above for compositions of the invention, including for example wherein the TPU component comprises polyester segments.

The invention also relates to a cured form of the composition according to the invention.

The invention further relates to an assembly comprising two substrates bonded together by the cured form of the composition of the invention.

A TPU component ‘based on’ a certain polyol is one in which said polyol has been used in the synthesis of said TPU component, or which forms a structural unit in said TPU component. Similarly, a polyol ‘based on’ diol units or dicarboxylic units is one in which said diol units or dicarboxylic acid units have been used in the synthesis of said polyol, or which form structural units in said polyol.

TPU components suitable for use in the present invention are those based on a polyol that is based on at least one diol or dicarboxylic acid characterised in that at least one of said diol or dicarboxylic acid has 6 carbon atoms (C₆) in the main chain and none of said diols or dicarboxylic acids have greater than 10 carbon atoms (>C₁₀) in their main chain. Following the IUPAC definition, as used herein the term “main chain” refers to that linear chain to which all other chains, long or short or both, may be regarded as being pendant. For example, in 5-methyl-1,12-dodecanedioic acid, the carbon atoms proceeding linearly from carbon 1 to carbon 12 constitute the main chain, whereas the carbon atom of the methyl group at position 5 is regarded as lying off the main chain; thus 5-methyl-1,12-dodecanedioic acid has 12 carbon atoms in the main chain. Similarly, a polyester polyol formed from a main chain-C₄ diol and a main chain C₆ or main chain-C₇ dicarboxylic acid, and thus comprising repeating elements with at least ten or eleven carbon atoms (bridged by an ester linkage) respectively, would not comprise a polyol based at least one diol or dicarboxylic acid characterised in that at least one of said diol or dicarboxylic acid has greater than 10 carbon atoms (>C₁₀) in the main chain.

Thermoplastic polyurethanes (TPUs) suitable for use as solidifying agents in the present invention include those, for example, formed from the reaction of polyisocyanate compounds with polyols that result in TPUs with a low glass transition temperature (Tg), such as from about −60° C. to −5° C., for example from about −50° C. to about −10° C. Glass transition temperatures (Tg) can be readily determined by techniques well known in the art, for example by differential scanning calorimetry. An example of a suitable polyol for practicing the current invention is Pearlbond 106, which is a linear aromatic polyurethane with a melt flow index (170° C./2.16 kg) of 10-30 g/10 min (as measured according to DIN 53.735), a melt viscosity (170° C./2.16 kg) of 1150 Pa·s (as measured according to DIN 53.735), a softening range of 62-66° C. (as measured according to MQSA 70 A), a melting range of 85-110° C. (as measured according to MQSA 70 A), a high crystallisation rate (as measured according to MQSA 12 B) and a very high thermoplasticity (as measured according to MQSA 68 A).

### DETAILED DESCRIPTION OF THE INVENTION

It has been surprisingly found that combining a thermoplastic polyurethane (TPU) with a curable cyanoacrylate component (such as, for example, ethyl cyanoacrylate, butyl cyanoacrylate, β-methoxy cyanoacrylate, or combinations thereof) at a relatively high weight percentage based on the total weight of the composition (greater than about 50 wt %) can be used to produce films with very high integrity.

The TPUs used in the curable compositions of the present invention are present in an amount of greater than about 50 wt % based on the total weight of the composition. Without wishing to be bound by any theorem, it is believed that this relatively high proportion of TPU in the composition is essential to achieve the high integrity of the film.

TPUs have shown excellent stability in various types of cyanoacrylate monomers.

TPUs have mechanical properties ranging between those of thermoplastic and thermoset materials. This is achieved by ‘virtual crosslinks’ caused by the H-bonding effect between urethane groups on opposite polymeric chains. This inter-chain H-bonding imparts various physical attributes to these unusual materials and manifests itself macroscopically in the form of excellent elasticity and elongation.

These rubbery or elastic-type properties make it possible to produce films of very high integrity.

Furthermore, TPU film formers have excellent tensile strength and elongation properties which offer benefits over other available film formers.

It is believed that the use of liquid cyanoacrylate monomers allows for better diffusion through the bulk than solid cyanoacrylate monomers, giving a faster room temperature cure.

When TPU materials are combined with liquid cyanoacrylate monomers, the resulting films not only have high internal structural integrity but also cure immediately on contact with standard substrates.

A TPU component ‘based on’ a certain polyol is one in which said polyol has been used in the synthesis of said TPU component, or which forms a structural unit in said TPU component. Similarly, a polyol ‘based on’ diol units or dicarboxylic units is one in which said diol units or dicarboxylic acid units have been used in the synthesis of said polyol, or which form structural units in said polyol.

TPU components suitable for use in the present invention are those based on a polyol that is based on at least one diol or dicarboxylic acid characterised in that at least one of said diol or dicarboxylic acid has 6 carbon atoms (C₆) in the main chain and none of said diols or dicarboxylic acids have greater than 10 carbon atoms (>C₁₀) in their main chain. Following the IUPAC definition, as used herein the term “main chain” refers to that linear chain to which all other chains, long or short or both, may be regarded as being pendant. For example, in 5-methyl-1,12-dodecanedioic acid, the carbon atoms proceeding linearly from carbon 1 to carbon 12 constitute the main chain, whereas the carbon atom of the methyl group at position 5 is regarded as lying off the main chain; thus 5-methyl-1,12-dodecanedioic acid has 12 carbon atoms in the main chain. Similarly, a polyester polyol formed from a main chain-C₄ diol and a main chain C₆ or main chain-C₇ dicarboxylic acid, and thus comprising repeating elements with at least ten or eleven carbon atoms (bridged by an ester linkage) respectively, would not comprise a polyol based at least one diol or dicarboxylic acid characterised in that at least one of said diol or dicarboxylic acid has greater than 10 carbon atoms (>C₁₀) in the main chain.

Without wishing to be bound by any theorem, it is believed that the use of a TPU component based on a polyol that is based on at least one diol or dicarboxylic acid characterised in that at least one of said diol or dicarboxylic acid has 6 carbon atoms (C₆) in the main chain and none of said diols or dicarboxylic acids have greater than 10 carbon atoms (>C₁₀) in their main chain reduces the likelihood of unwanted crystallisation occurring.

TPUs based on >C₁₀ diols or dicarboxylic acids are used in the preparation of solid cyanoacrylate compositions, during which the longer polyol chains are believed to facilitate crystallisation and subsequent solidification.

This crystallisation process, however, can be detrimental during the preparation of compositions for use in adhesive tapes, as it can cause opacity and has the potential to affect component registration during final assembly.

As used herein, the word ‘tape’ refers to an article comprising a curable composition and one or more release liners.

As used herein, the phrase ‘stabiliser’, or ‘Lewis acid stabiliser’ refers to a substance that stabilises the curable cyanoacrylate component, for example by inhibiting premature polymerisation of the cyanoacrylate. Examples of such substances include boron trifluoride (BF₃) or sulfur dioxide (SO₂). The skilled person will readily appreciate that other suitable stabilisers, for example another suitable Lewis acid, could be used to stabilise the curable cyanoacrylate component. It is disclosed that stabiliser solutions can be prepared using ethyl cyanoacrylate, β-methoxy cyanoacrylate, or butyl cyanoacrylate as the carrier for the stabiliser, said stabiliser solutions being suitable for adjusting the amount of stabiliser in curable compositions based on ethyl cyanoacrylate, β-methoxy cyanoacrylate, or butyl cyanoacrylate respectively.

Formulation of the compositions and products of the present invention can be achieved by combining a thermoplastic polyurethane (TPU) component with a solvent and stirring at elevated temperatures. Desirably, the mixture is stirred at about 1330 rpm with a dissolver blade at an elevated temperature, for example at about 65° C. The actual temperature used may vary depending on the melting point of the TPU used or its solubility. Mixing is performed for a time sufficient to dissolve the TPU component into the solvent, which can vary depending on the batch size. At this stage, a stabiliser may be added. The curable cyanoacrylate component is then added to the composition. Without wishing to be bound by any theorem, it is believed that the late addition of the cyanoacrylate component has a beneficial effect on the stability of the final product.

The adhesive formulation can be applied to a substrate, such as for example a release liner, optionally by casting. The substrate can be left for a period of time, for example about 5 minutes, optionally at an elevated temperature, such as for example about 60° C., to facilitate removal of the solvent. After this period, the film thickness may be substantially smaller than the wet coating thickness. Once the solvent has evaporated, rapid spooling may be carried out in order to prevent dust particles or moisture from contacting the surface of the film.

### BRIEF DESCRIPTION OF THE DRAWINGS

Embodiments of the invention will be described, by way of example only, with reference to the accompanying drawings in which:

FIG. 1 depicts the results of tensile shear testing on several substrates using an adhesive tape prepared from a cyanoacrylate composition according to Example 1 of the present invention and provides a comparison of the performance of Example 1 and DURO-TAK 9640.

FIG. 2 depicts the results of tensile shear testing on several substrates using an adhesive tape prepared from a cyanoacrylate composition according to Example 2 of the present invention and provides a comparison of the performance of Example 2 and DURO-TAK 9640.

FIG. 3 depicts the results of tensile shear testing on several substrates using an adhesive tape prepared from a cyanoacrylate composition according to Example 3 of the present invention and provides a comparison of the performance of Example 3 and DURO-TAK 9640.

FIG. 4 depicts the results of T-peel testing obtained using adhesive tapes prepared with cyanoacrylate compositions according to the present invention and provides a comparison of their performance with that of DURO-TAK 9640.

FIG. 5 depicts the results of side impact tests obtained using compositions according to the present invention and provides a comparison of their performance with that of DURO-TAK 9640.

### EXAMPLES

Example compositions 1-3, suitable for practising the present invention, were prepared as detailed below.

The ethyl acetate solvent was placed in a suitable vessel and TPU component Pearlbond 106 was added. The mixture was stirred and brought to a temperature of about 65° C. Full dissolution of the TPU component occurred under high shear mixing at 1330 rpm with a dissolver blade in approximately 1-2 hours. A boron trifluoride stabiliser was then added, followed by the relevant cyanoacrylate monomer.

Table 1 provided below summarises the compositions of Examples 1-3.

TABLE 1

Mass/g

| Component | Example 1 | Example 2 | Example 3 |
|---|---|---|---|
| Pearlbond 106 | 300.0 | 300.0 | 250.0 |
| Ethyl acetate | 300.0 | 300.0 | 250.0 |
| Butyl cyanoacrylate | 162.0 | 0 | 0 |
| β-methoxy cyanoacrylate | 0 | 162.0 | 60.8 |
| Boron trifluoride (1000 | 24.3 | 24.3 | 16.4 |
| ppm solution in ethyl | | | |
| cyanoacrylate) | | | |

The compositions of Examples 1-3 were used to prepare adhesive tapes suitable for practising the present invention.

Each adhesive formulation was coated onto a siliconized polyester film available from PPI films (SRF 122/75 μm). A wet coating thickness of 150 microns was used. The film was dried for 5 minutes at 60° C. to facilitate the removal of the ethyl acetate solvent, after which film thickness was approximately 60 μm. Once dried the adhesive tape was transferred under mild finger pressure to the substrate to be tested. This ease of transfer (instant tack) is achieved due to the presence of the liquid monomer.

Table 2 provided below shows the weight percentages of each component in the compositions of Examples 1-3 after removal of the solvent. Weight percentages are based on the total weight of the composition.

TABLE 2

| | Percentage by weight | | |
|---|---|---|---|
| Component | Example 1 | Example 2 | Example 3 |
| Pearlbond 106 | 62% | 62% | 76% |
| Butyl cyanoacrylate | 33% | 0% | 0% |
| β-methoxy cyanoacrylate | 0% | 32% | 19% |
| Boron trifluoride (1000 | 5% (50 ppm | 5% (50 ppm | 5% (50 ppm |
| ppm solution in ethyl | BF₃) | BF₃) | BF₃) |
| cyanoacrylate) | | | |

The adhesive tapes prepared from the compositions of Examples 1-3 were subjected to several comparative tests to assess their performance compared to control composition DURO-TAK9640. DURO-TAK9640 is a cyanoacrylate tape based on a solid cyanoacrylate monomer and a polyethylene/polyvinylacetate film former. Tensile shear (across various substrates), T-peel (grit blasted mild steel (GBMS)), and side impact testing was carried out.

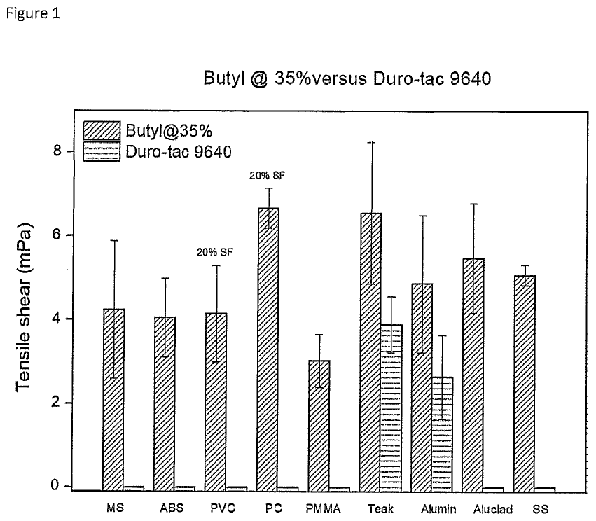

The results of tensile shear testing with an adhesive tape of the invention according to the composition of Example 1, based on butyl cyanoacrylate, are shown in FIG. 1. Tensile shear tests were performed in accordance with ASTM D 1002 (2000). The tensile strength of the tape was measured across various substrates and compared to that of DURO-TAK 9640. Bonds were assembled at room temperature (25° C.), and testing was carried out after a further 24 h at room temperature. In FIGS. 1-3, ‘SF’ is used to report substrate failure, which occurs when the bond is stronger than the substrate causing the substrate to break before the bond. Each tensile shear test was carried out 5 times so 20% substrate failure, for example, is reported when substrate failure was observed in one of the 5 experiments.

The adhesive tape prepared with the composition of Example 1 showed significantly improved performance over DURO-TAK9640 across all substrates tested. The greatest tensile shear values measured for the composition of Example 1 were on PC (polycarbonate) and teak substrates.

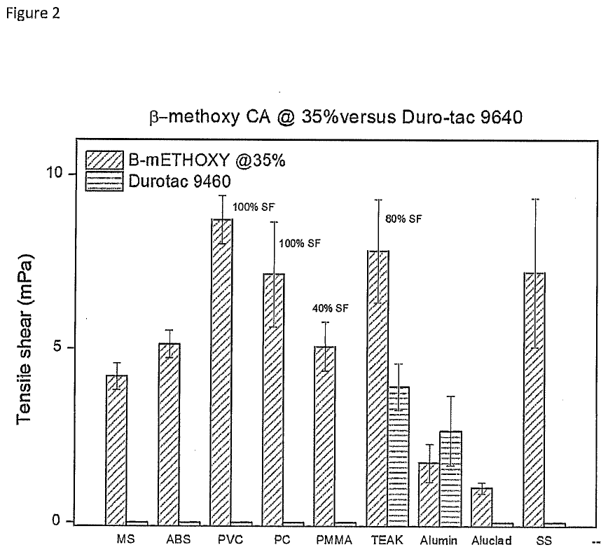

The results of tensile shear testing with an adhesive tape of the invention according to the composition of Example 2, based on β-methoxy cyanoacrylate, are shown in FIG. 2. The tensile strength of the tape was measured across various substrates and compared to that of DURO-TAK9640. Bonds were assembled at room temperature (25° C.), and testing was carried out after a further 24 h at room temperature.

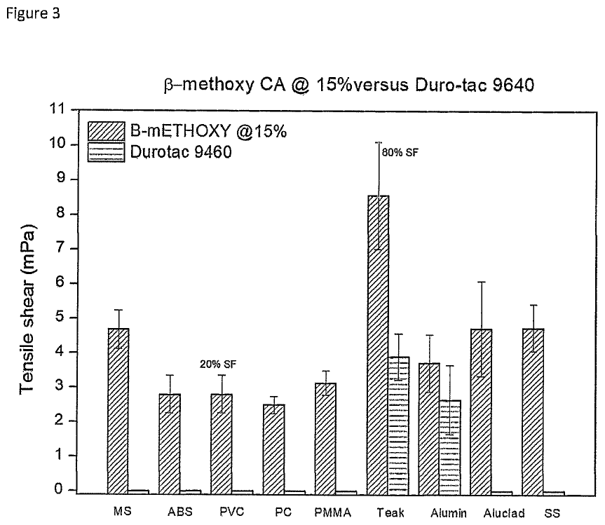

The adhesive tape prepared with composition Example 2 showed significantly improved performance over DURO-TAK9640 across almost all substrates tested, being outperformed only when tested on aluminium. The greatest tensile shear value was measured on a teak substrate. The results of tensile shear testing with an adhesive tape of the invention according to the composition of Example 3 are shown in FIG. 3. Example 3 is also based on 8-methoxy cyanoacrylate but the cyanoacrylate component is present in a lower proportion than in Example 2. The tensile strength of the tape was measured across various substrates and compared to that of DURO-TAK9640. Bonds were assembled at room temperature (25° C.), and testing was carried out after a further 24 h at room temperature.

The adhesive tape prepared with the composition of Example 3 showed improved performance over DURO-TAK9640 across all substrates tested. Again, the highest tensile shear value was measured on a teak substrate.

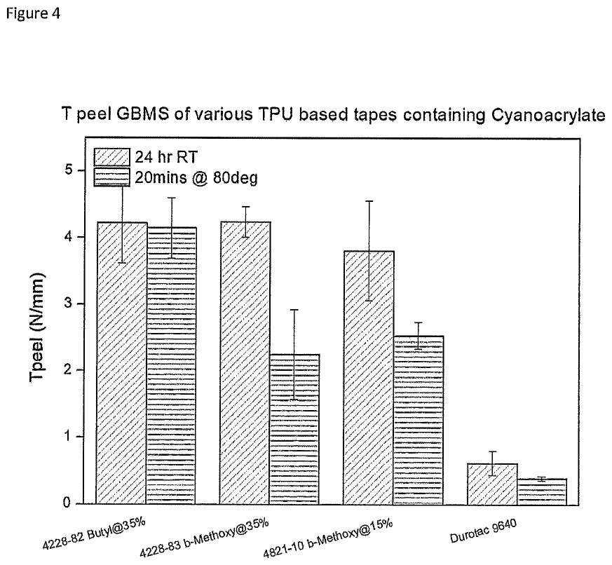

The T-peel performance of the tapes prepared with the compositions of Examples 1-3 were measured and compared with control composition DURO-TAK9640. T-peel testing was carried out in accordance with ASTM D 1876 (2010). Tests were performed on a substrate of grit blasted mild steel (GBMS) using T-peel coupons 25.4 mm wide and 150 mm long, following cure for either 24 h at room temperature (25° C.) or 24 h at room temperature followed by a further 20 minutes at 80° C. The results of the T-peel testing are shown in FIG. 4.

For both sets of cure conditions, all of the example compositions tested showed substantially improved performance over DURO-TAK9640. Excellent T-peel performance was exhibited by all of the example compositions. The highest T-peel values were achieved by Examples 1 and 2 when cured for 24 h at room temperature. For all compositions tested, T-peel performance was higher when cured at room temperature than when cured at room temperature followed by a 20-minute cure at 80° C. However, even the lowest T-peel value obtained for the example compositions tested was several times higher than either of the values observed for DURO-TAK9640.

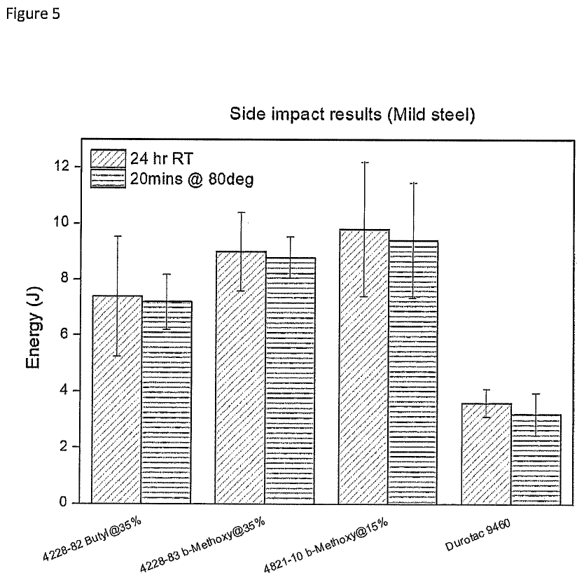

The side impact performance of the tapes prepared with the compositions of Examples 1-3 were measured and compared with control composition DURO-TAK9640. Side impact testing was carried out in accordance with STM 812. Tests were performed on a substrate of mild steel, following cure for either 24 h at room temperature (25° C.) or 24 h at room temperature followed by a further 20 minutes at 80° C. The results of the side impact testing are shown in FIG. 5.

All of the example compositions tested showed excellent side impact performance, significantly outperforming control composition DURO-TAK9640. The results obtained with a 24 h cure at room temperature followed by a further 20 minutes at 80° C. were comparable to those achieved with the room temperature cure only.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

What is claimed is:

1. A curable composition comprising:
(i) a curable cyanoacrylate component; and
(ii) at least one thermoplastic polyurethane (TPU) component; and
wherein said at least one TPU component (ii) has a mass average molar mass Mw from 40,000-80,000, and
wherein said at least one TPU component (ii) is based on a polyol that is based on at least one diol or dicarboxylic acid wherein said at least one diol or dicarboxylic acid has 6 carbon atoms (C₆) in its main chain and further wherein none of said diols or dicarboxylic acids have greater than 10 carbon atoms (>C₁₀) in their main chain, and
wherein said at least one TPU component (ii) is present in the curable composition in an amount of greater than about 50 wt %, wherein the weight percentage is based on the total weight of the composition.

2. A curable composition according to claim 1, wherein the cyanoacrylate component (i) is a liquid curable cyanoacrylate component.

3. A curable composition according to claim 1, wherein the cyanoacrylate component (i) is selected from the group comprising ethyl cyanoacrylate, butyl cyanoacrylate, β-methoxy cyanoacrylate and combinations thereof.

4. A curable composition according to claim 1, wherein the cyanoacrylate component (i) is present in the curable composition in an amount from about 10 wt % to about 35 wt %, wherein the weight percentage is based on the total weight of the composition.

5. A curable composition according to claim 1, further comprising a solvent selected from the group comprising ethyl acetate, tetrahydrofuran, methyl ethyl ketone, cyclohexanone, and acetone.

6. A curable composition according to claim 5, wherein the solvent used is ethyl acetate.

7. A curable composition according to claim 1, wherein said at least one TPU component (ii) is present in the curable composition in an amount from about 65 wt % to about 85 wt % wherein the weight percentage is based on the total weight of the composition.

8. A curable composition according to claim 1, wherein said at least one TPU component (ii) has a glass transition temperature of from about −60° C. to about −5° C.

9. A curable composition according to claim 1, wherein said at least one TPU component (ii) has a glass transition temperature of from about −55° C. to about −20° C.

10. A curable composition according to claim 1, wherein said at least one TPU component (ii) comprises polyester segments.

11. A curable composition according to claim 1, wherein said at least one TPU component (ii) comprises polyester segments, based on at least one of a C6 diol or a C6 carboxylic acid.

12. A curable composition according to claim 1 wherein said at least one TPU component (ii) is based on a polyester polyol formed from a C6 dicarboxylic acid and one of either 1,6-hexane diol or 1,4-butane diol.

13. A curable composition according to claim 1 wherein said at least one TPU component (ii) is based on a (co)polyester of hexanedioic acid and one of either 1,4-butane diol or 1,6-hexanediol, said (co)polyester having a melting point of about 50-80° C., and with an OH number of less than about 0.5%, for example less than about 0.1% (as measured according to standard procedure DIN 53240-2).

14. A curable composition according to claim 1 further comprising from about 10 ppm to about 200 ppm of a stabiliser of the cyanoacrylate component.

15. A curable composition according to claim 14, wherein the stabiliser is selected from boron trifluoride (BF₃) or sulfur dioxide (SO₂).

16. A curable composition according to claim 14, wherein the stabiliser is sulfur dioxide (SO₂).

17. A curable composition according to claim 1, comprising two TPU components, wherein each of said two TPU components has a mass average molar mass Mw from 40,000-80,000, and
wherein each of said two TPU components is based on a polyol that is based on at least one diol or dicarboxylic acid wherein said at least one diol or dicarboxylic acid has 6 carbon atoms (C₆) in its main chain and further wherein none of said diols or dicarboxylic acids have greater than 10 carbon atoms (>C₁₀) in their main chain, and
wherein said two TPU components are present together in the curable composition in a total amount greater than about 50 wt %, wherein the weight percentage is based on the total weight of the composition.

18. A curable composition according to claim 1 provided in tape form.

19. A tape comprising a curable composition according to claims 1 and one or more release liners.

20. A method of preparing a curable composition comprising the steps of:
i) combining at least one thermoplastic polyurethane (TPU) component with a curable cyanoacrylate component as set out in claim 1 and a solvent to form a mixture;
ii) applying the mixture of step (i) to a substrate, optionally by casting;
iii) allowing the solvent to evaporate or actively removing the solvent, thereby forming a solid form curable composition.

21. The method of claim 20 wherein the substrate is a release liner.

22. The method of claim 21, wherein the solvent is ethyl acetate.

23. The composition according to claim 1 in cured form.

24. An assembly comprising two substrates bonded together by the cured form of the composition according to claim 1.
